(19) United States
(12) Patent Application Publication
(10) Pub. No.: US 2024/0234942 A1
(43) Pub. Date: Jul. 11, 2024

(54) METHOD FOR MANUFACTURING A SOLID-STATE ELECTROLYTE FOR A BATTERY CELL

(71) Applicant: Volkswagen Aktiengesellschaft, Wolfsburg (DE)

(72) Inventors: Tobias JANSEN, Braunschweig (DE); Stephan Leonhard KOCH, Salzgitter (DE); Miriam KUNZE, Seelze (DE)

(73) Assignee: Volkswagen Aktiengesellschaft, Wolfsburg (DE)

(21) Appl. No.: 18/409,597

(22) Filed: Jan. 10, 2024

(30) Foreign Application Priority Data
Jan. 10, 2023 (DE) 10 2023 200 133.0

(51) Int. Cl. H01M 50/403; H01M 10/0562; H01M 50/451

(52) U.S. Cl. CPC H01M 50/403; H01M 10/0562; H01M 50/451; H01M 2300/0068

(57) ABSTRACT

A method for manufacturing a solid-state electrolyte for a battery cell, wherein a ceramic green body is provided, wherein the green body is sintered to form a solid-state electrolyte material, and wherein after the sintering, the solid-state electrolyte material is coated on the electrode side with a protective layer made of polytetrafluoroethylene, and is subsequently cooled.

This nonprovisional application claims priority under 35 U.S.C. § 119(a) to German Patent Application No. 10 2023 200 133.0, which was filed in Germany on Jan. 10, 2023, and which is herein incorporated by reference.

### BACKGROUND OF THE INVENTION

### Field of the Invention

The invention relates to a method for manufacturing a solid-state electrolyte for a battery cell. The invention further relates to a solid-state electrolyte, to a battery cell, and to use of polytetrafluoroethylene (PTFE) as a protective layer for sa solid-state electrolyte material.

### Description of the Background Art

Electrically or electromotively driven or drivable motor vehicles such as electric or hybrid vehicles, for example, generally include an electric motor via which one or both vehicle axles are drivable. For supplying electrical energy, the electric motor is typically connected to a vehicle-internal (high-voltage) battery as an electrical energy store.

An electrochemical battery can be understood here and in the following discussion to mean a so-called secondary battery of the motor vehicle. In such a (secondary) vehicle battery, consumed chemical energy is recoverable by means of an electrical (re)charging process. These types of vehicle batteries are designed, for example, as electrochemical storage batteries, in particular as lithium-ion storage batteries.

To generate or provide a sufficiently high operating voltage, such vehicle batteries typically include at least one battery module (battery cell module) in which multiple individual battery cells are modularly interconnected. Alternatively, a so-called Cell2Pack design is possible in which the battery cells are directly connected to the vehicle battery, in particular in parallel, and not combined beforehand to form modules.

The battery cells are designed, for example, as electrochemical (thin-)layer cells. The thin-layer cells have a layered design with a cathode layer (cathode) and an anode layer (anode), and a separator layer (separator) situated in between. A liquid electrolyte, for example, that establishes an ion-conductive connection of the components or a charge compensation passes through these components. Multiple layer cells are generally stacked on top of one another as a cell stack.

Layer cells containing a solid-state electrolyte (solid electrolyte, SE), also referred to below as solid-state cells, solid cells, or all solid-state battery (ASSB) cells, for the same installed weight and/or installed volume, have a higher energy storage density than layer cells containing liquid electrolytes. Batteries containing solid-state cells are also referred to below as solid-state batteries (SSBs).

In solid-state batteries, the electrodes or electrode layers, i.e., the cathodes with a catholyte or the anodes (not Li metal) with an anolyte, are stacked, with a solid-state electrolyte (ceramic, glass, or glass ceramic) as separator, to form a cell stack. The anolyte and/or the catholyte may be made of a polymer or a ceramic, or a glass or a glass ceramic.

For solid-state batteries, the solid-state electrolyte is important for the energy density, power density, and safety of the solid-state cell or the battery. However, separators made of lithium-conducting (lithium ion-conducting) solid-state electrolytes are often very unstable with respect to humidity and atmospheric oxygen. For solid-state cells, for example sulfidic solid-state electrolytes, i.e., solid-state electrolytes containing a sulfidic compound, are used on account of a high ionic conductivity. However, sulfide-based solid-state electrolytes disadvantageously have low stability in air. In particular, a chemical reaction of the sulfidic solid-state electrolyte with moisture in the air may result in gaseous hydrogen sulfide (H₂S). Hydrogen sulfide is a toxic, corrosive, combustible gas, which at concentrations of even 5 parts per million (ppm) may result in irritation of the eyes, nose, and throat.

In addition, during cooling within the scope of a sintering process or manufacture of the lithium ion-conducting ceramic of the solid-state electrolyte, vaporization of lithium occurs, in which a considerable portion of the lithium evaporates from the separator. The lithium vaporization and the reaction with air components reduce the lithium conductivity, and thus, the performance of the solid-state electrolyte for solid-state cells.

In the manufacture of a solid-state cell or solid-state battery, it is generally desirable to form the lithium anode in situ in the solid-state battery during the first charging cycle. However, in order for this deposition to take place properly, it is absolutely necessary for the surface of the solid electrolyte separator to have certain properties.

To protect the air-sensitive solid-state electrolyte material against reactions with atmospheric moisture (water) or carbon dioxide (CO₂), the cell manufacture or production of the solid-state cell is carried out, for example, under a protective gas atmosphere or in a drying chamber having a low dew point (−40° C., for example). This results in high costs in manufacturing the solid-state electrolyte, which disadvantageously increases the manufacturing costs for the battery cell or solid-state cell.

Furthermore, the processing takes place using protective plates having a high lithium content in order to counteract lithium vaporization. In addition, for example a nickel layer is applied to the sintered solid-state electrolyte material for deposition of the lithium in situ. However, nickel (Ni) as a deposition layer brings additional weight into the system, and also cannot be applied in any desired thickness. This results in a reduction of the gravimetric and volumetric energy density of the solid-state cell. In addition, the nickel application process results in a higher reject rate.

### SUMMARY OF THE INVENTION

It is therefore an object of the invention to provide a particularly suitable method for manufacturing a solid-state electrolyte for a battery cell. In particular, the intent is to provide moisture protection and binding to an anode and/or cathode. A further object underlying the invention is to provide a particularly suitable solid-state electrolyte and a particularly suitable battery cell, as well as a particularly suitable use.

The advantages and examples stated in conjunction with the method are also analogously transferable to the solid-state electrolyte and/or the battery cell and/or the use, and vice versa.

The method according to the invention is provided for manufacturing a solid-state electrolyte (solid electrolyte separator) for a battery cell, i.e., a solid-state cell or solid cell, and is suitable and designed for this purpose.

According to the method, a ceramic green body (green sheet) is initially provided. A green body can be understood to mean an unfired or unsintered blank in the manufacture of sintered workpieces.

The green body is subsequently sintered in a sintering process to form a solid-state electrolyte material. According to the invention, after the sintering or after the sintering process the solid-state electrolyte material is coated on the electrode side with a protective layer made at least partially of polytetrafluoroethylene (PTFE) and is subsequently cooled. A particularly suitable manufacturing method is implemented in this way. In particular, the solid-state electrolyte material coated with PTFE is completely coolable and may be further processed under standard room conditions (ambient temperature and ambient humidity). The PTFE protective layer in particular provides humidity or moisture protection, so that during further processing the solid-state electrolyte material does not come into direct contact with ambient air/atmospheric moisture, and therefore no drying chamber or protective gas is needed for the further processing. The further processing is thus significantly simplified. The PTFE protective layer also improves the binding to an electrode of the battery cell. Furthermore, the solid-state electrolyte manufactured in this way has a higher energy density (gravimetric as well as volumetric) compared to application of a Ni layer. The PTFE protective layer is preferably designed to be thinner than a conventional metallic protective layer. In other words, the PTFE protective layer has a reduced layer thickness compared to metallic protective layers. The reduced density and thickness of the PTFE protective layer thus result in further advantages with regard to the installed weight.

“On the electrode side” can be understood here and in the following discussion to mean in particular the side or surface of the solid-state electrolyte material facing an electrode or electrode layer, i.e., an anode (anode layer) or a cathode (cathode layer), during operation. The solid-state electrolyte or separator is situated in the battery cell between the cathode and the anode in the manner of a sandwich, so that the solid-state electrolyte material has two end-face or planar electrode sides: an anode side and a cathode side.

On the anode side the PTFE may establish a tight connection with a current collector. This means that the PTFE protective layer on the anode side may also act as an adhesive layer. When used in a battery cell, the PTFE protective layer also allows lithium ions to be conducted through the PTFE and subsequently deposited in situ as lithium metal.

On the cathode side, the PTFE protective layer achieves good binding of the cathode layer to a sulfidic, polymeric, or gel electrolyte. The coating on the cathode side also protects the solid electrolyte from decomposition and decomposition products during operation of the battery cell.

The method according to the invention allows particularly low process costs in manufacturing the solid-state electrolyte, since a separate inert gas or protective gas atmosphere for the processing is not necessary after the PTFE coating. In addition, the solid-state electrolyte material manufactured in this way has improved storage capability and reduced aging.

In a design, a protective layer made completely of PTFE can be applied. Thus, a protective layer made of pure PTFE, i.e., a protective layer composed of 100% PTFE, is applied.

In an example, not just one electrode side (anode side or cathode side), but instead both electrode sides, i.e., the anode side and the cathode side, of the solid-state electrolyte material can be coated. In other words, after the sintering the solid-state electrolyte material is coated on both sides with the protective layer. This ensures enhanced protection of the solid-state electrolyte material and improved binding to the anode and to the cathode.

According to the invention, the PTFE protective layer can be applied after the sintering. An additional or further aspect of the invention provides that the solid-state electrolyte material is coated with the protective layer while the solid-state electrolyte material has a temperature between 200° C. (degrees Celsius) and 250° C. This means that the coating is carried out above temperatures of 200° C. to 250° C. while the ceramic solid electrolyte material is in the cooling step after the sintering. The PTFE is still stable here, and water or moisture cannot yet deposit on the solid electrolyte material and disadvantageously react with it.

The protective layer can be applied by spraying onto the at least one electrode side of the solid-state electrolyte material. The spraying is particularly advantageous at high temperatures of the solid-state electrolyte material, since a direct application of the protective layer after the sintering process is thus made possible. Due to the spraying, direct contact of a coating device with the hot solid-state electrolyte material is avoided, thus improving the service life of the coating device.

IThe spraying may take place using a solution of PTFE in a solvent. The solvent evaporates directly upon application to the still hot solid-state electrolyte material, thus further cooling the solid-state electrolyte material. This facilitates a higher process speed, thus advantageously lowering the manufacturing costs.

For manufacturing-related reasons, the electrodes (anode, cathode) as well as the solid-state electrolyte material have at least a certain surface roughness. For a solid cell, however, for good charge transport it is necessary for the contact between the cell layers, in particular between the electrode layer and the separator layer or solid-state electrolyte layer, to be as close as possible. However, due to the roughness of the surfaces, completely flat contacting of the two cell layers is often not achieved. In addition to the improved production design, the application of PTFE coating also advantageously results in compensation of surface roughnessness of the electrodes or of the solid-state electrolyte material, so that overall, no inhomogeneous pressure distributions occur which could result in fracturing of the solid-state electrolyte. To ensure the most homogeneous binding possible of the solid-state electrolyte material to the current collector and/or the electrodes, in one preferred design the protective layer is applied to the solid-state electrolyte material with a layer thickness between 0.05 μm (micron) and 10 μm, in particular between 0.1 μm and 5 μm. A particularly homogeneous deposition of the lithium is ensured in this way.

The solid-state electrolyte (separator) according to the invention is provided for a battery cell (solid cell/solid-state cell) and is suitable and configured for this purpose. According to the invention, the solid-state electrolyte includes a sintered ceramic solid-state electrolyte material that is coated on the electrode side with a protective layer made of PTFE. A solid electrolyte separator with humidity protection and with binding for an anode and/or cathode is achieved in this way.

The battery cell according to the invention includes a solid-state electrolyte described above. The battery cell is in particular a solid cell or solid-state cell.

According to the invention, polytetrafluoroethylene can be used as a protective layer for a sintered ceramic solid-state electrolyte material of a solid-state electrolyte of a battery cell. On the one hand, reliable moisture protection of the solid-state electrolyte is thus achieved. On the other hand, particularly homogeneous binding to an anode and/or cathode is thus achievable.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flow chart for a method for manufacturing a solid-state electrolyte, and

FIG. 2 shows a battery cell that includes the solid-state electrolyte.

### DETAILED DESCRIPTION

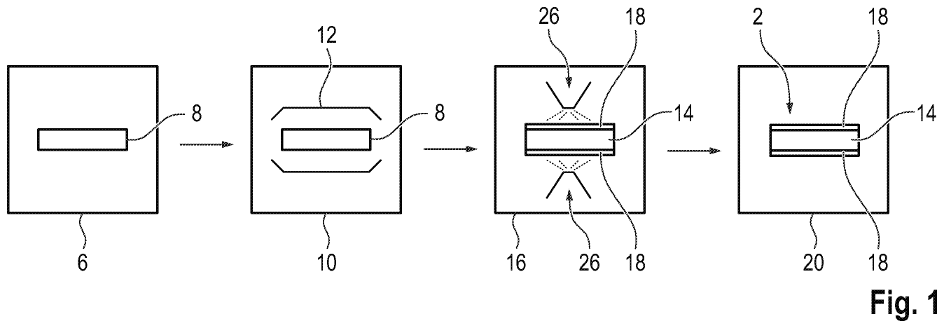

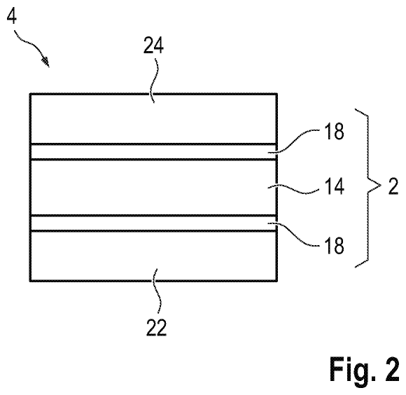

FIG. 1 schematically shows successive illustrations of a method for manufacturing a solid-state electrolyte 2 that is usable as a separator in a (solid-state) battery cell 4 (FIG. 2). The solid-state electrolyte 2 is also referred to below as a solid-state electrolyte separator 2.

A ceramic green body 8 is provided in a first method step 6. The green body 8 is subsequently sintered in an oven 12 in a method step 10 by means of a sintering process to form a solid-state electrolyte material 14.

After the sintering, in a method step 16 the solid-state electrolyte material 14 is coated on both sides with a protective layer 18 made of pure polytetrafluoroethylene (PTFE) and is subsequently cooled in a method step 20.

The coating process 16 essentially immediately follows the sintering process 10, the solid-state electrolyte material 14 being coated with the protective layer 18 while the solid-state electrolyte material 12 (still) has a temperature between 200° C. (degrees Celsius) and 250° C. This means that the coating is carried out above temperatures of 200° C. to 250° C. The protective layer 18 is preferably applied to the solid-state electrolyte material 14 by spraying by means of spray nozzles 26.

The solid-state electrolyte 2 is preferably used as a separator in the battery cell 4 and is situated between two electrodes or electrode layers 22, 24 in the manner of a sandwich. In the coating process 16, the surfaces of the solid-state electrolyte material 14 facing the electrodes 22, 24, i.e., the anode 22 and the cathode 24, are coated with the protective layer 18. The protective layers 18 are applied in a sufficient layer thickness so that unevennesses of the anode 22 and cathode 24 due to surface roughness are compensated for. For this purpose, the protective layer 18 is applied to the solid-state electrolyte material 14 with a layer thickness between 0.05 μm and 10 μm, for example.

During the cooling 20, the solid-state electrolyte material 14 coated with PTFE is completely cooled and may subsequently be further processed under standard room conditions. The protective layer 18 on both sides provides humidity or moisture protection, so that during the further processing the solid-state electrolyte material 14 does not come into direct contact with ambient air and/or atmospheric moisture.

The claimed invention is not limited to the exemplary embodiment described above. Rather, within the scope of the disclosed claims, other variants of the invention may also be deduced by those skilled in the art without departing from the subject matter of the claimed invention. In particular, within the scope of the disclosed claims, all individual features described in conjunction with the exemplary embodiment may also be combined in some other way without departing from the subject matter of the claimed invention.

What is claimed is:

1. A method for manufacturing a solid-state electrolyte for a battery cell, the method comprising:
providing a ceramic green body;
sintering the green body to form a solid-state electrolyte material;
coating, after the sintering, the solid-state electrolyte material on an electrode side with a protective layer made at least partially of polytetrafluoroethylene; and
cooling the solid-state electrolyte material.

2. The method according to claim 1, wherein the protective layer is made completely of polytetrafluoroethylene.

3. The method according to claim 1, wherein, after the sintering, the solid-state electrolyte material is coated on both sides with the protective layer.

4. The method according to claim 1, wherein the solid-state electrolyte material is coated with the protective layer while the solid-state electrolyte material has a temperature between 200° C. and 250° C.

5. The method according to claim 1, wherein the protective layer is applied by spraying onto the solid-state electrolyte material.

6. The method according to claim 1, wherein the protective layer is applied to the solid-state electrolyte material with a layer thickness between 0.05 μm and 10 μm.

7. A solid-state electrolyte for a battery cell, comprising a sintered solid-state electrolyte material that is coated on an electrode side with a protective layer made of polytetrafluoroethylene.

8. A battery cell comprising a solid-state electrolyte according to claim 7.

9. A protective layer formed of a polytetrafluoroethylene, the protective layer provided for a solid-state electrolyte material of a solid-state electrolyte of a battery cell.
